(19) United States
(12) Patent Application Publication
(10) Pub. No.: US 2006/0196436 A1
(43) Pub. Date: Sep. 7, 2006

(54) Adjustable dish holder

(76) Inventor: Jim Quentin Nichols, Kennedale, TX (US)

Correspondence Address: LYNN E BARBER, P O BOX 16528, FORT WORTH, TX, 76162, US

(21) Appl. No.: 11/072,381

(22) Filed: Mar. 4, 2005

(51) Int. Cl. A01K 5/01

(52) U.S. Cl. 119/61.53

(57) ABSTRACT

An adjustable dish holder for pets and having adjustable dish holder for pets, having a lower support stand with support arms attached to an inner telescoping leg portion, and an upper dish support portion having a hollow outer telescoping leg portion that fits over the inner telescoping leg portion and dish holding structure, which may have cylindrical or rectangular openings for the dishes. The height of a pet dish may be adjusted by moving the outer telescoping leg portion up or down with respect to the inner telescoping leg portion, and then fixing the position of the outer telescoping leg portion with respect to the position of the inner telescoping leg portion.

### BACKGROUND OF THE INVENTION

1. Field of the Invention

This invention relates to animal feeding apparatuses, and in particular relates to an adjustable dish holder that may be used for pets.

2. Description of the Related Art

Typically, animals such as dogs and cats are fed in dishes placed at floor level. It is known, however, that it may be injurious to the health of an animal, particularly a large animal, to eat at floor level. In addition, feed containers placed on the floor are easily accessible to crawling insects.

Thus, elevated pet feeders have been developed such as the pet dining table of Steininger (U.S. Pat. No. Des. 377,244) and the dog feeder of Fahmie (U.S. Pat. No. 4,065,195), which is composed of a top panel with holes to receive feeding pans, and three hinged support panels that hold the top panel above the floor level and that may be collapsed in coplanar position to be portable. The pet feeder of Teschke (U.S. Pat. No. 4,699,089) elevates a removable feeding table by placing it on a feed storage container.

It has been recognized, however, that having a fixed height feeder does not allow the pet owner to make adjustments for differently sized pets. Patents addressing this problem include U.S. Pat. No. 4,044,723 of Fitzpatrick, which provides a table supported by legs to hold the food dishes. The legs may be detachably secured to the table so that one set of legs may be replaced by another set of legs of a different length as is desired. U.S. Pat. Nos. Des. 258,018 of Venditto and Des. 424,759 of Sipka are also for a height adjustable platform for feeding pets.

The feeding tray means of Brown (U.S. Pat. No. 4,658,759) has an elevated rectangular plate having extendible legs hinged to the bottom of the plate. The feeder holder of Altman (U.S. Pat. No. 5,429,071) provides two pairs of rigid L-shaped legs, each of which has slots so that U-shaped brackets may be inserted in opposing aligned slots to define a platform for holding a feeder above a pan of water to keep crawling insects from getting to the feed. The pet food serving apparatus of Mersits et al. (U.S. Publication No. US2003/0106498) also elevates a food tray above a moat, and may be adjusted in height by means of threaded leg sections, by vertical spacers, or by cut-out notches in the leg for insertion of the food tray.

The adjustable animal feeder of Lemkin (U.S. Pat. No. 6,145,474) has two molded plastic components: an upwardly opening hollow base, and a downwardly opening hollow cover for holding bowls. There are ribs spaced about the interior of the cover and grooves spaced about the perimeter of the base, so that when the cover is placed in one position, the ribs slide down the grooves and the bowls are in a lowered position, and when the cover is placed in another position, the ribs rest on the upper ends of the walls of the base and the bowls are in an elevated position.

The trough support of Swinney (U.S. Pat. No. 3,145,007) utilizes stanchions which have a trough carrying sleeve surrounding the stanchion, and a pawl and ratchet mechanism to change the height of the trough.

The adjustable pet feeding stand of Cooper (U.S. Pat. No. 3,651,787) has side walls with apertured leg portions, and apertured extensible support members that may be held in different positions with respect to the leg portions by means of fastening elements placed through the apertures.

Patents providing vertical structures upon which the height of feeders may be adjusted include U.S. Pat. No. Des. 424,758 of Akopdjanov (double bowl structure positionable at any one of a number of holes in the vertical structure), U.S. Pat. No. 4,205,629 of Wix (horizontal frame for holding bowls at different heights on a mounted support member), U.S. Pat. No. 5,000,124 of Bergen (wall mounting apparatus having a trigger and brake device so that bowl can be held at a particular elevation), U.S. Pat. No. 5,501,176 of Tully (bracket with horizontal slots has a tray attached to any one of the horizontal slots by means of a hinge), and U.S. Pat. No. 4,976,223 of Pierce (support base with at least two arms extending upwardly and having means to engage a food dish support plate).

Other adjustable feeders have multiple legs which may be adjusted in position to change the height of the feeder, such as U.S. Pat. No. 2,165,968 of Hill (legs adjusted longitudinally through slots.

Many prior feeding devices have a very complicated or bulky structure making them difficult to construct and/or to move from position to position, or they are not adjustable in height at all, or have very limited adjustability.

It is therefore an object of the invention to provide an adjustable dish holder for pets that is adjustable to multiple heights, is easily assembled and disassembled, and movable from one position to another.

Other objects and advantages will be more fully apparent from the following disclosure and appended claims.

### SUMMARY OF THE INVENTION

The invention herein is an adjustable dish holder for pets having a lower support stand with support arms attached to an inner telescoping leg portion, and an upper dish support portion having a hollow outer telescoping leg portion that fits over the inner telescoping leg portion and at least one dish-holding structure. The height of a pet dish may be adjusted by moving the outer telescoping leg portion up or down with respect to the inner telescoping leg portion, and then fixing the position of the outer telescoping leg portion with respect to the position of the inner telescoping leg portion.

Other objects and features of the inventions will be more fully apparent from the following disclosure and appended claims.

### BRIEF DESCRIPTION OF THE DRAWINGS

FIG. 1 is an upper side perspective view of a first embodiment of an adjustable dish holder according to the invention herein, in a lowered position, with pet dishes inserted.

FIG. 2 is an upper perspective view of the adjustable dish holder of FIG. 1 with pet dishes removed.

FIG. 3 is an upper side perspective side view of the adjustable dish holder of FIG. 1 in a raised position, with pet dishes inserted.

FIG. 4 is an upper side perspective view of the adjustable dish holder of FIG. 3, with the dishes removed.

FIG. 5 is an end perspective view of the adjustable dish holder of FIG. 4.

FIG. 6 is a partial perspective view of the inside of one dish-holding cylinder of the adjustable dish holder of FIG. 1.

FIG. 7 is a lower perspective view of the upper dish support portion of the adjustable dish holder of FIG. 1.

FIG. 8 is a side perspective view of the lower support stand of the adjustable dish holder of FIG. 1.

FIG. 9 is a lower perspective view of the lower support stand of the adjustable dish holder of FIG. 1.

FIG. 10 is a plan view of a metal piece used to make the dish-holding cylinder of the FIG. 1.

FIG. 11 is a partial cross-sectional view of the protective tube cap of the adjustable dish holder of FIG. 1 showing the upper end of the inner telescoping leg portion in two alternate positions.

FIG. 12 is a perspective view of the adjustable dish holder of FIG. 1 in use.

FIG. 13 is an upper side perspective view of a second embodiment of an adjustable dish holder according to the invention herein, in a raised position with pet dishes inserted.

FIG. 14 is an upper side perspective view of the adjustable dish holder of FIG. 13 with pet dishes removed and in a lowered position.

FIG. 15 is an elevational end view of the adjustable dish holder of FIG. 13 in a raised position.

FIG. 16 is an elevational end view of the adjustable dish holder of FIG. 13 in a lowered position.

FIG. 17 is an elevational side view of the adjustable dish holder of FIG. 13 in a lowered position.

FIG. 18 is an top perspective view of the upper dish support portion of the adjustable dish holder of FIG. 13.

FIG. 19 is a bottom perspective view of the adjustable dish holder of FIG. 13 in a raised position.

FIG. 20 is a bottom perspective view of the adjustable dish holder of FIG. 13 in a lowered position.

FIG. 21 is a partial lower plan view of the adjustable dish holder of FIG. 13 showing the outer telescoping portion.

FIG. 22 is a perspective side view of a lower support stand for the second embodiment of the adjustable dish holder of the invention.

FIG. 23 is a partial perspective view showing the interior weld area of the upper dish support portion of the adjustable dish support holder of FIG. 13.

### DETAILED DESCRIPTION OF THE INVENTION AND PREFERRED EMBODIMENTS THEREOF

The present invention is for an adjustable dish holder providing a functional, economic and attractive method to hold serving dishes in place and elevate them to the correct height for small animals and pets, such as dogs and cats, enhancing digestion, improving accessibility to the food and water dishes, and decreasing pest access to the dishes. The height adjustment of the dish holder is simply and easily done, without the use of tools or supplementary fasteners, through a hidden adjustment device, and at each of the possible heights, the invention provides the same stability. The dish holder is portable and may be easily moved from one location to another without changing the height setting. The dish holder contains a dish support that is decorative. It also may be made in different sizes.

There are two main embodiments of the invention discussed in detail herein. In each of the embodiments, there is at least one lower support stand, with each lower support stand comprising at least one support arm attached to an inner telescoping leg portion. Each embodiment also comprises an upper dish support portion comprising a hollow outer telescoping leg portion that fits over the inner telescoping leg portion, and a dish-holding structure that allows support of at least one pet dish, and preferably two pet dishes. In the first embodiment this dish-holding structure is a dish-holding cylinder, and in the second embodiment, this dish-holding structure is a rectangular box. The height of a dish placed in the dish-holding structure may be adjusted by moving the outer telescoping leg portion up or down with respect to the inner telescoping leg portion, and then fixing the position of the outer telescoping leg portion with respect to the position of the inner telescoping leg portion.

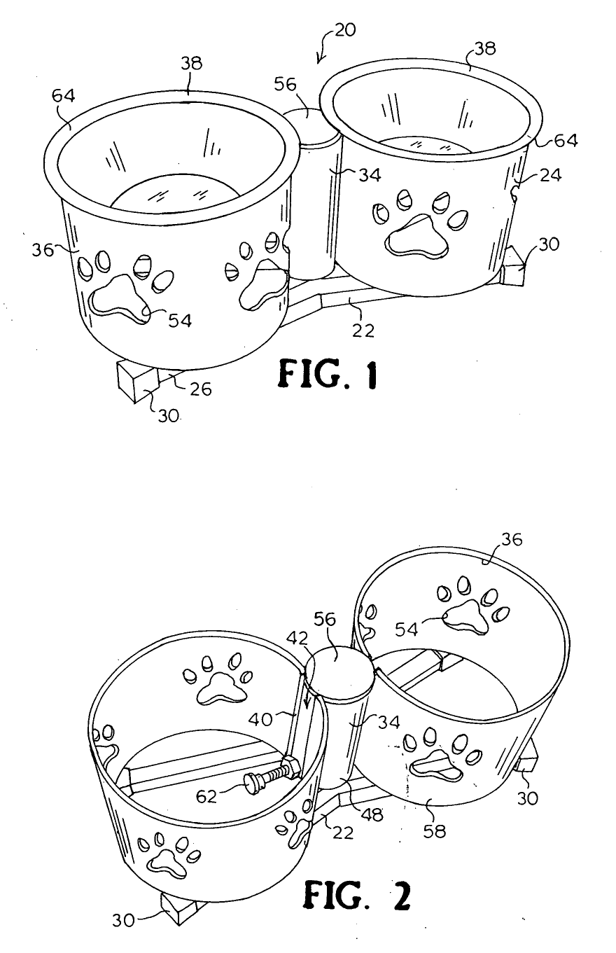

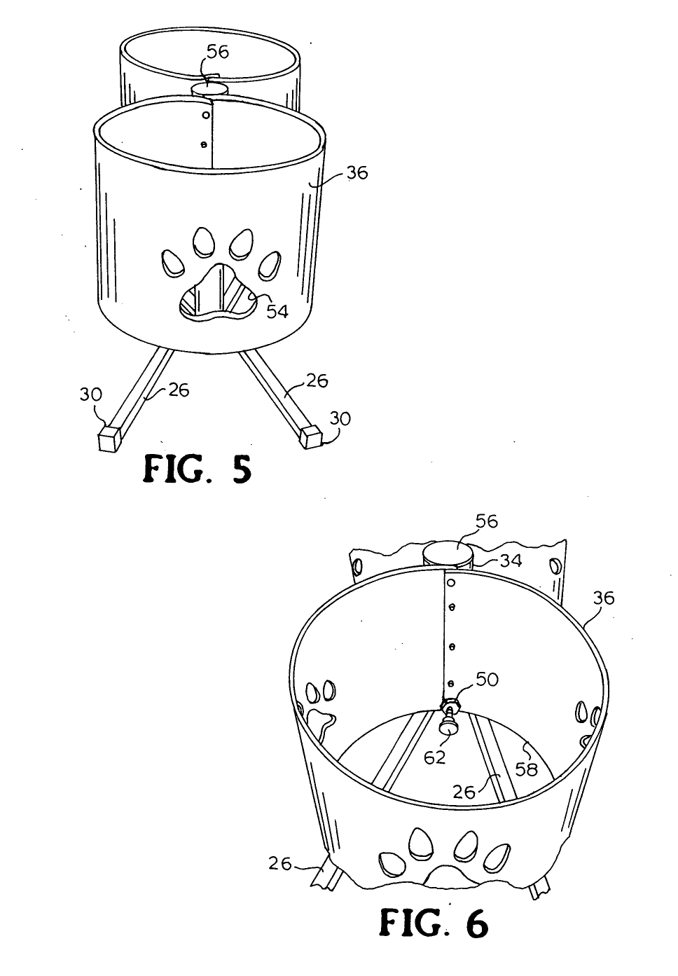

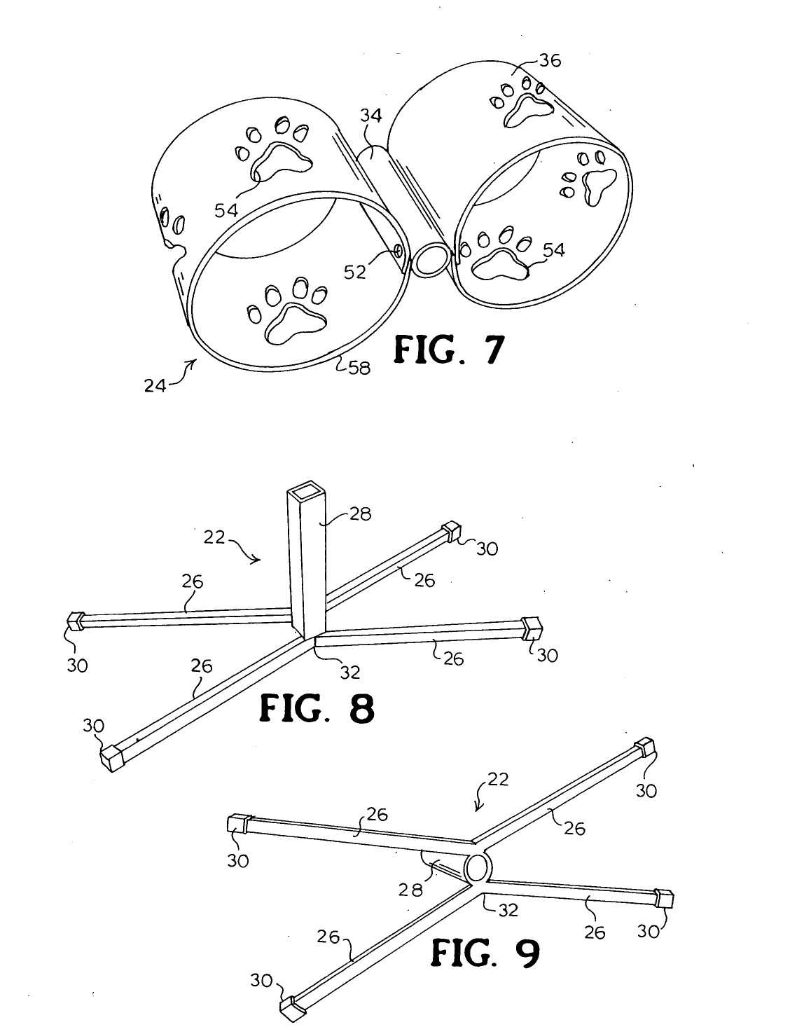

Referring now to the figures, the adjustable dish holder 20 in the first embodiment of the invention herein (FIGS. 1-6) comprises a lower support stand 22 (FIGS. 8-9) and an upper dish support portion 24 (FIG. 7). The preferred lower support stand 22 as shown in FIGS. 8-9 comprises a plurality of support arms 26 attached to an inner telescoping leg portion 28 in a manner to provide a stable support for the adjustable dish holder 20 of the invention when assembled as discussed herein. Preferably the support arms 26 are attached perpendicularly to the base 29 of the vertically aligned inner telescoping leg portion. Preferably, the ends of the support arms are tipped with rubber or other floor protectors 30 as are known in the art. Although different arrangements of support arms 26 are clearly possible, for example, more support arms, or support arms arranged in different configurations, in Applicant's preferred first embodiment shown herein there are two support arms 26, slightly bent in their central area 32 as shown in FIG. 9, for example an angle of about 20-30 degrees from the horizontal on each end. Any angle bend, however, such as a more acute angle bend, may be used so long as the support as constructed is stable in use. The support arms 26 are preferably made of ½-inch square or round hollow tubing. For a particular dish holder 20, the support arms 26 are preferably adjusted in length, type and size as is known in the art to make the invention stable.

In the preferred first embodiment shown herein, the central area 32 of each of the support arms 26 is attached, preferably by being welded using assembly jigs, or otherwise permanently attached as is known in the art, to the inner telescoping leg portion 28 as shown. The inner telescoping leg portion 28 is preferably hollow and while shown as cylindrical in most figures, is more preferably square in cross-section as shown in FIG. 8. Alternatively, inner telescoping leg portion 28 could be another shape as is desired. In one variation for smaller animals, the inner telescoping leg portion 28 is about 4.25 inches long; while in another variation for somewhat larger animals, the inner telescoping leg portion 28 is about 7 inches long. Other sizes could of course be made for other sizes of animals as is desired. The larger size not only allows for taller animals to feed and drink, but also results in a heavier dish holder that is not so easily shoved around by the animal.

The upper dish support portion 24 comprises a hollow outer telescoping leg portion 34 as shown in FIG. 7, preferably centrally placed between two dish-holding cylinders 36, and having an inner diameter and shape sized for placement over the inner telescoping leg portion 28. There is at least one, and most preferably two, dish-holding cylinders 36 welded or otherwise permanently attached to the outer telescoping leg portion 34. Preferably these two dish-holding cylinders 36 are the same size, and are sized to hold identical pet dishes 38 as shown, however, there could be two dish sizes and corresponding differences in the dish-holding cylinders 36, for example, a large one for water. Shapes other than cylindrical, e.g., hexagonal, could also be used for the dish-holding cylinders 36.

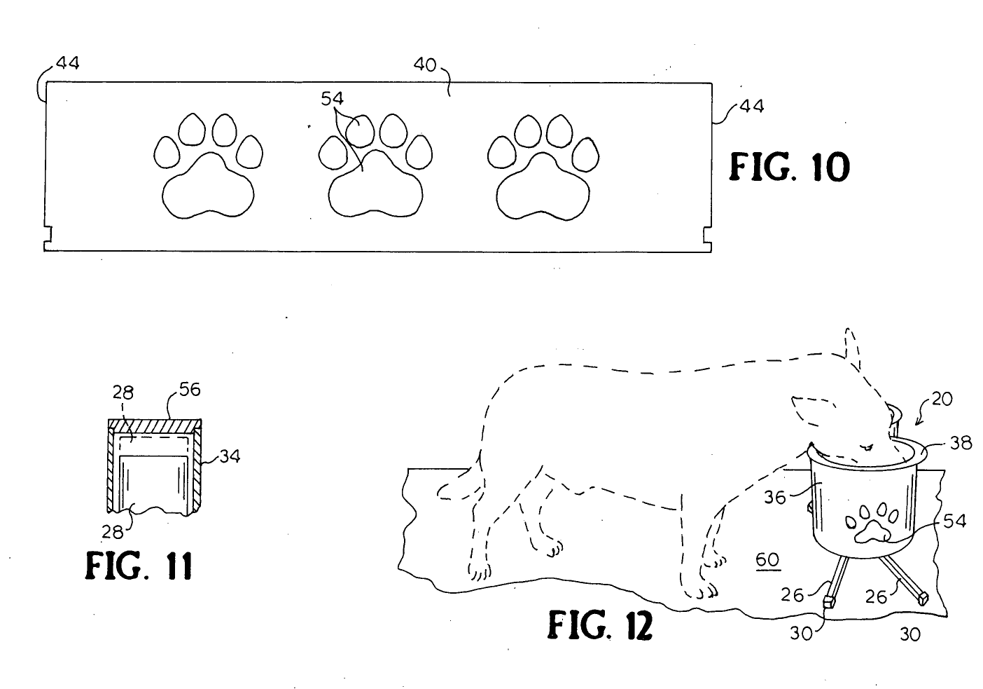

In one preferred embodiment (FIG. 2), each dish-holding cylinder 36 is an incomplete cylinder; alternatively, the dish-holding cylinder 36 may be a complete cylinder welded to the outer telescoping leg portion (FIG. 7). In either case, dish-holding cylinder 36 is preferably made of a flat metal piece 40 (FIG. 10) cut to size and stamped or cut-out as desired, such as for decorative purposes, with the ends of the bent flat metal piece 40 each being welded to the outer telescoping leg portion 34. When dish-holding cylinder 36 is an incomplete cylinder, there is a gap 42 between the ends 44 as shown in FIG. 2. Prior to attaching the flat metal piece 40 to the outer telescoping leg portion 34, a hole 46 is made through the outer telescoping leg portion 34 toward the lower end 48 of the outer telescoping leg portion 34, so that the hole 46 is located in the gap 42 between the ends 44 of one of the bent flat metal pieces 40, once the flat metal piece 40 is attached to the outer telescoping leg portion 34. The hole 46 is made by standard techniques, for example, by machining into it, followed by honing of the internal diameter for proper clearance. An adjustment nut 50, such as ¼×20, is welded or otherwise permanently attached to the outside of the outer telescoping leg portion 34 over the hole 40 as shown. When the dish-holding cylinder 36 is a complete cylinder, a half-hole or slot is cut at each end of the lower portion of flat piece that is used to form the cylinder 36, after bending. When the ends of the cylinder meet, they form the complete hole 52, which when assembled is aligned with hole 46 in the outer telescoping leg portion 34 (FIG. 7). A cage nut that is placed between the two ends of the cylinder before it is welded to the outer telescoping leg portion 34. Alternatively, a weld nut that would attach to the outer telescoping leg portion 34 may be use.

In any case, it is preferred to have cut-out designs 54 in the dish-holding cylinders 36, primarily for decorative purposes, such as the pet paw print design shown in FIGS. 1-7 and 12 for the first embodiment of the invention. Embossed designs or painted designs (not shown) may be used instead of, or in addition to the cut-out designs 54.

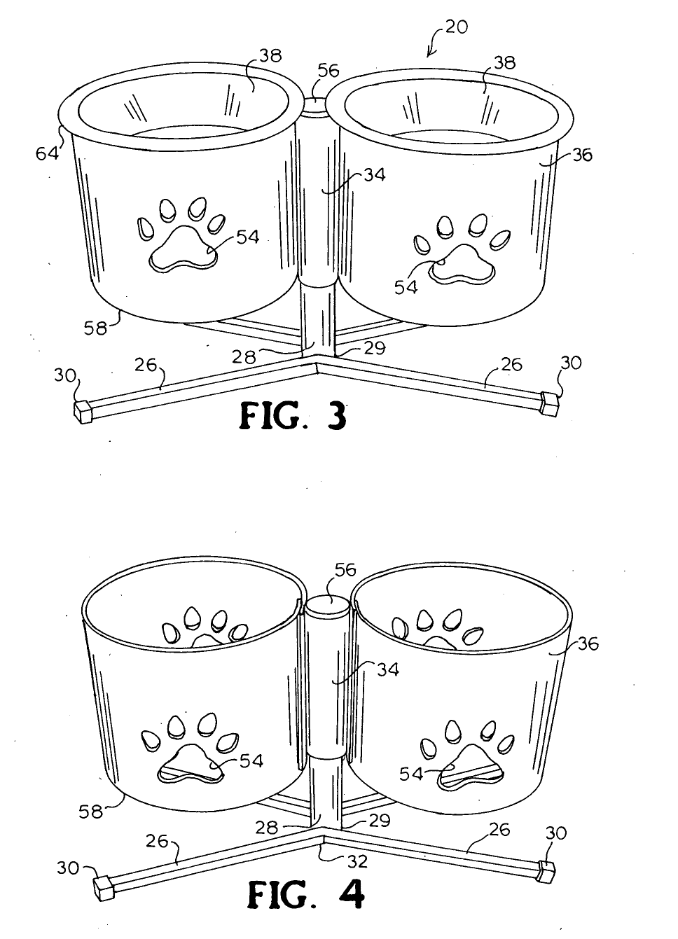

The outer telescoping leg portion 34 has an upper protective tube cap 56 (FIGS. 1-2, 11) closing off the top of the outer telescoping leg portion 34. The cap 56 could simply be a piece welded across the opening of the outer telescoping portion 34, or could be a cylinder sized to fit at the top of the outer telescoping leg portion 34, with spring steel projections (not shown) extending downward on its edge so that when the projections are pushed into the top of the outer telescoping leg portion 34, the cap is held there. Thus, when the upper dish support portion 24 is placed on the lower support stand 22 by placing the outer telescoping leg portion 34 over the inner telescoping leg portion 28, animal food and the like cannot fall down the center of these leg portions. When the upper dish support portion 24 is thus placed all the way down on the lower support stand 22, the lower edge 58 of the dish-holding cylinder 36 rests on the support arms 26, or on the floor protectors 30 (FIGS. 1-2). If it is desired to raise the height of the dishes 38, the upper dish support portion 24 may be pulled upward, with the outer telescoping leg portion 34 being moved upward along the inner telescoping leg portion 28 to the desired height above the floor surface 60 (FIGS. 3-4). The upper dish support portion 34 is held at the desired height by placement of an adjustment screw 62 through the adjustment nut 50 and the hole 46 in the outer telescoping leg portion (and the hole 52 in the dish-holding cylinder 36 if present), and then tightening of the adjustment screw 62 against the inner telescoping leg portion 28 to hold the upper dish support portion 24 in place. Preferably the adjustment screw 62 is a nylon screw to minimize scratching of the inner telescoping leg portion 28 while still holding the outer telescoping leg portion 34 firmly in place.

Although the adjustable dish holder 20 of the first embodiment of the invention may be constructed in many different sizes and proportions, it has been found that the following dimensions provide a dish holder usable for most dogs and cats: small-4.8 inches diameter; medium 7.8 inches diameter and large 10.8 inches diameter. Each part, however, can be expanded or modified to increase the range of function or usefulness for the user's intended purpose, appearance and attractiveness, such as dish holder shape or size, telescoping leg size, shape, length and number, and support arm design.

Once the lower support stand 22 and the upper dish support portion 24 are individually constructed, they are cleaned and coated with a durable finish (not shown) for indoor and outdoor use. Floor protectors 30 are installed and dishes 38 are placed in the dish holding cylinders. Preferably, easily cleanable pet dishes of a size with rims 64 that rest on the top of the dish-holding cylinders 36 are used, such as stainless steel dishes. Dishes with embossed or other permanent designs that match designs on the dish holding cylinders may be used. Examples of such designs with a pet paw print are shown in FIG. 1.

An example of use of the adjustable dish holder 20 of the invention is shown in FIG. 12.

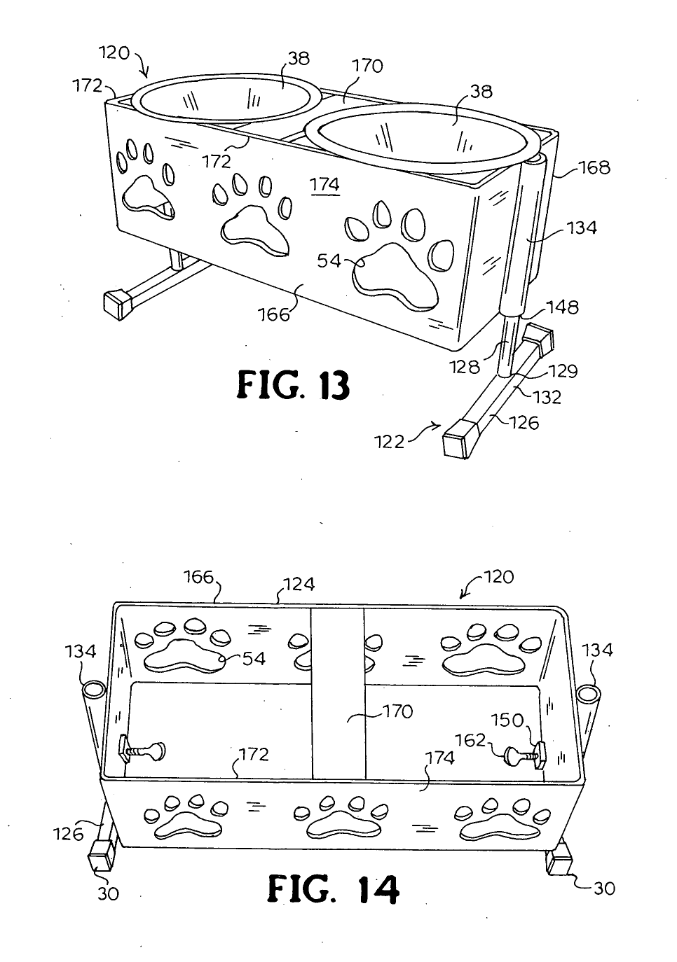

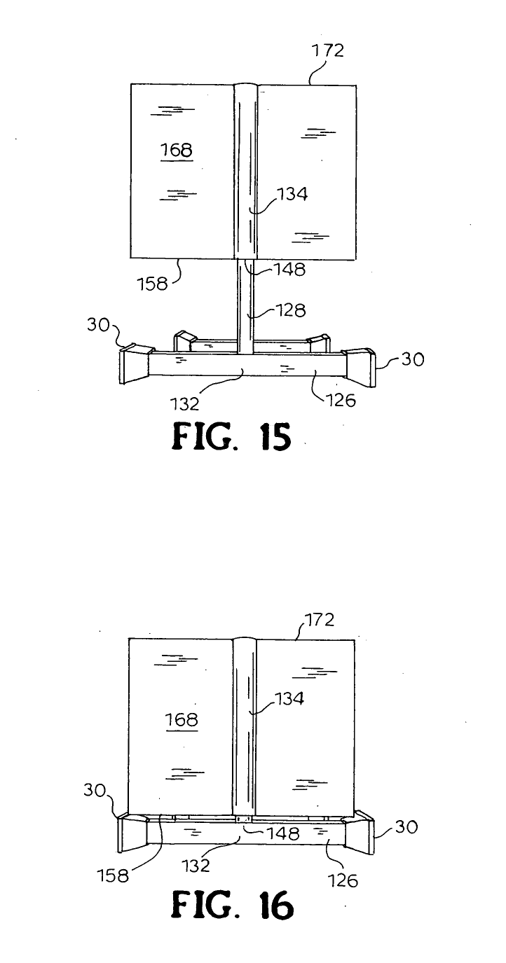

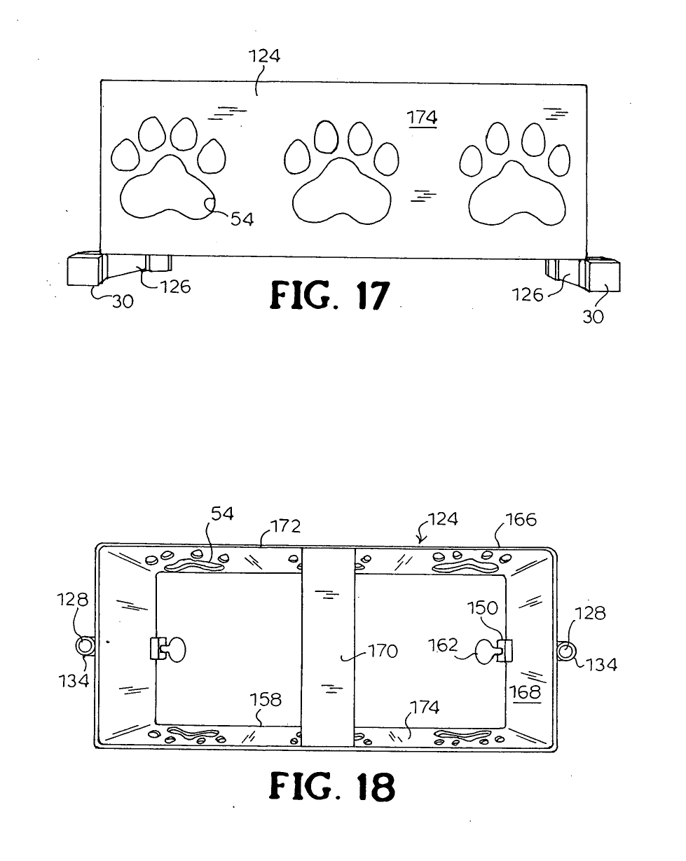

The adjustable dish holder 120 in the second embodiment of the invention herein (FIGS. 13-17, 19-20) and comprises a lower support stand 122 (FIG. 22) and an upper dish support portion 124 that comprises rectangular box 166 that supported by support arms 126 (FIG. 18). Rectangular box 166 is preferably made of two flat metal pieces 140 (FIG. 10) cut to size and stamped or cut-out as desired, such as for decorative purposes, with the ends of the bent flat metal pieces 140 being welded to each other to form rectangular box 166 (FIG. 23).

The preferred two lower support stands 122 as shown in FIG. 22 each comprise a support arm 126 attached perpendicularly to the base 129 of a vertically aligned inner telescoping leg portion 128 to provide a stable support for the adjustable dish holder 120 of the invention when assembled as discussed herein. Preferably, the ends of each support arm are tipped with rubber or other floor protectors 130 as are known in the art. The support arms 126 are preferably made as in the first embodiment.

In the preferred second embodiment shown herein, the central area 132 of each of the support arms 126 is attached, preferably by being welded using assembly jigs, or otherwise permanently attached as is known in the art, to the inner telescoping leg portion 128 as shown. The inner telescoping leg portion 28 is preferably hollow and is preferably cylindrical, or alternatively square or another shape. In one variation for smaller animals, the inner telescoping leg portion 28 is about 4.25 inches long; while in another variation for somewhat larger animals, the inner telescoping leg portion 28 is about 7 inches long. Other sizes could of course be made for other sizes of animals as is desired. The larger size not only allows for taller animals to feed and drink, but also results in a heavier dish holder that is not so easily shoved around by the animal.

The upper dish support portion 124 in the second embodiment is generally a four-sided rectangular box 166 that is open at the top and bottom. The upper dish support portion 124 has two hollow outer telescoping leg portions 134 as shown in FIG. 18 each of which is positioned external to the rectangular box 166 centrally along an end 168 of the upper dish support portion 124. Each hollow outer telescoping leg portion 134 has an inner diameter and shape sized for placement over the inner telescoping leg portion 128.

Preferably half-way between the ends 168 of the upper dish support portion 123, a central upper cross-bar 170 is fastened to the top 172 of the upper dish support portion 124 as shown in FIGS. 18-20 and extends across the rectangular box 166 between the sides 174. The upper cross-bar 170 is preferably made of flat metal and separates the dishes, and is sufficiently wide and sturdy to support the weight of pet dishes 38 placed in the opening formed on each side of the upper cross-bar 170 within the rectangular box. Upper cross-bar 170 is preferably attached to the sides 174 of the upper dish portion by welding or other means known in the art; for example, the cross-bar may be made to be somewhat longer than the opening between the sides 174, and bent downward on its ends so that they can be welded inside the upper dish support portion to hold the central portion of the cross-bar at the same level as the top 172 of the upper dish support portion as shown.

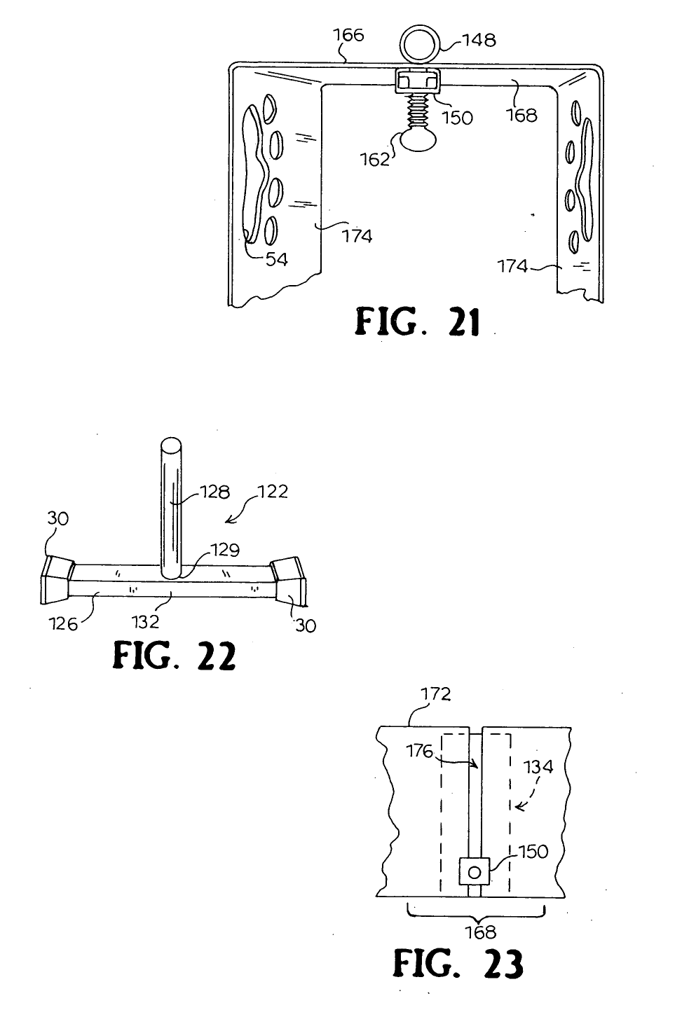

Prior to attaching the flat metal piece 140 to the outer telescoping leg portion 134, a hole (not shown) is made through the outer telescoping leg portion 34 toward the lower end 148 of the outer telescoping leg portion 134, and another hole (not shown) is made in the corresponding central position toward the lower edge of the end 168 of the upper support stand 124. The holes are made by standard techniques, for example, by machining into it, followed by honing of the internal diameter for proper clearance. An adjustment nut 150, such as a cage nut, is welded or otherwise permanently attached to the inside of the end 168 over the holes (FIGS. 21, 23).

In any case, it is preferred to have cut-out designs 54 in the rectangular box 166, primarily for decorative purposes, such as the pet paw print design shown in FIGS. 13-14 and 17 for the second embodiment of the invention.

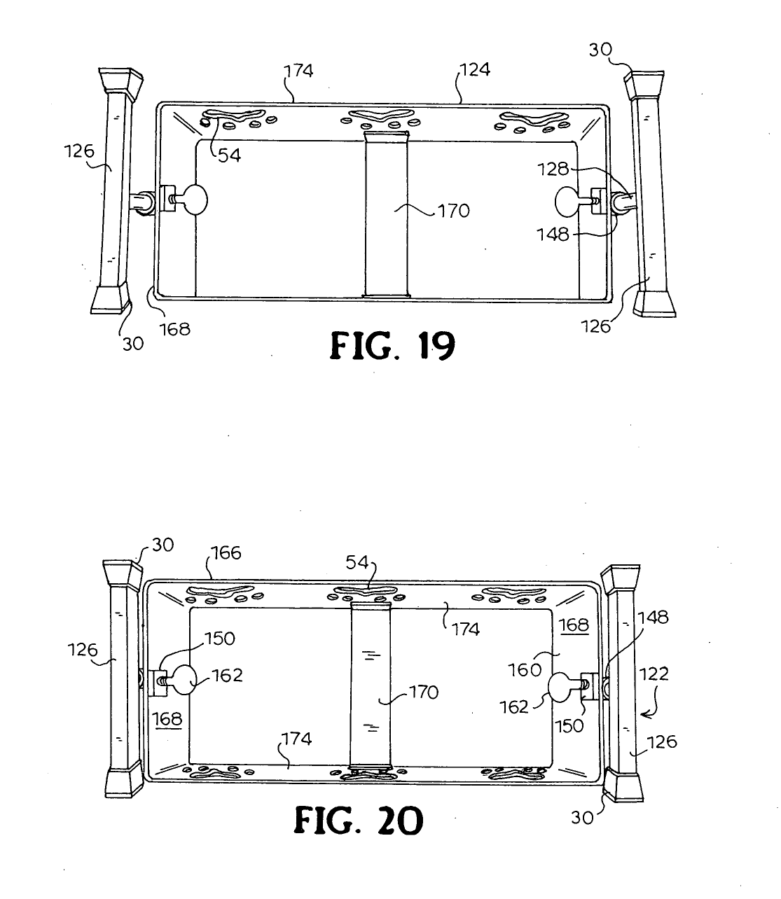

When the upper dish support portion 124 is placed all the way down on the lower support stand 122, the lower edge 158 of the rectangular box 166 rests on the support arms 126, or on the floor protectors 130 (FIG. 20). If it is desired to raise the height of the dishes 38, the upper dish support portion 124 may be pulled upward, with the outer telescoping leg portion 134 being moved upward along the inner telescoping leg portion 128 to the desired height above the floor surface 60 (FIG. 19). The upper dish support portion 134 is held at the desired height by placement of an adjustment screw 162 through the adjustment nut 150 and the aligned holes in the outer telescoping leg portion, and then tightening of the adjustment screw 162 against the inner telescoping leg portion 128 to hold the upper dish support portion 124 in place. Preferably the adjustment screw 162 is a nylon screw to minimize scratching of the inner telescoping leg portion 128 while still holding the outer telescoping leg portion 134 firmly in place.

Although the adjustable dish holder 120 of the first embodiment of the invention may be constructed in many different sizes and proportions, the dimensions given for the first embodiment are preferred and provide a dish holder usable for most dogs and cats. Each part, however, can be expanded or modified to increase the range of function or usefulness for the user's intended purpose, appearance and attractiveness, such as dish holder shape or size, telescoping leg size, shape, length and number and support arm design.

Once the lower support stand 122 and the upper dish support portion 124 are individually constructed, they are cleaned and coated with a durable finish (not shown) for indoor and outdoor use. Floor protectors 130 are installed and dishes 38 are placed in the dish holding cylinders. Preferably, easily cleanable pet dishes of a size with rims 64 that rest on the top of the upper cross-bar 170 and upper edges of the rectangular box 166, such as stainless steel dishes as in the first embodiment discussed above.

While the invention has been described with reference to specific embodiments, it will be appreciated that numerous variations, modifications, and embodiments are possible, and accordingly, all such variations, modifications, and embodiments are to be regarded as being within the spirit and scope of the invention.

What is claimed is:

1. An adjustable dish holder for pets, comprising:
a) at least one lower support stand, each lower support stand comprising at least one support arm attached to an inner telescoping leg portion; and
b) an upper dish support portion comprising:
i. a hollow outer telescoping leg portion that fits over the inner telescoping leg portion; and
ii. a dish-holding structure,
wherein the height of a dish placed in a dish-holding structure may be adjusted by moving the outer telescoping leg portion up or down with respect to the inner telescoping leg portion, and then fixing the position of the outer telescoping leg portion with respect to the position of the inner telescoping leg portion.

2. The adjustable dish holder for pets according to claim 1, wherein the dish-holding structure comprises a dish-holding cylinder.

3. The adjustable dish holder for pets according to claim 2, wherein there are two dish-holding cylinders.

4. The adjustable dish holder for pets according to claim 2, wherein there are two support arms.

5. The adjustable dish holder for pets according to claim 4, wherein the two support arms have a central area where they are each bent slightly, and wherein the lower end of the inner telescoping leg portion is attached to the central area of the support arms.

6. The adjustable dish holder for pets according to claim 2, wherein the dish-holding cylinder has cut-out decorative holes.

7. The adjustable dish holder for pets according to claim 2, further comprising an upper protective tube cap closing off the top of the outer telescoping leg portion.

8. The adjustable dish holder for pets according to claim 1, wherein the dish-holding structure comprises a rectangular box.

9. The adjustable dish holder for pets according to claim 8, further comprising a cross-bar across the top of the rectangular box.

10. The adjustable dish holder for pets according to claim 8, wherein there are two support stands, with one support stand at each end of the rectangular box.

11. The adjustable dish holder for pets according to claim 8, wherein the rectangular box has cut-out decorative holes.

12. The adjustable dish holder for pets according to claim 1, wherein the outer telescoping leg portion has a hole and an adjustment nut attached to the outside of the outer telescoping leg portion over the hole, wherein the position of the outer telescoping leg portion with respect to the position of the inner telescoping leg portion is fixed by threading an adjustment screw through the nut and hole and tightening the adjustment screw against the inner telescoping leg portion.

13. The adjustable dish holder for pets according to claim 12, wherein the adjustment screw is a nylon screw.

14. The adjustable dish holder for pets according to claim 1, wherein the position of the outer telescoping leg is fixed by a hidden adjustment.

15. The adjustable dish holder for pets according to claim 1, wherein the position of the outer telescoping leg is fixed using an adjustment screw.

16. The adjustable dish holder for pets according to claim 14, wherein the adjustment screw is a nylon screw.

17. The adjustable dish holder for pets according to claim 1, wherein the support arms are tipped with floor protectors.

18. The adjustable dish holder for pets according to claim 1, wherein the outer telescoping leg portion has a hole and an adjustment nut attached to the outside of the outer telescoping leg portion over the hole, wherein the position of the outer telescoping leg portion with respect to the position of the inner telescoping leg portion is fixed by threading an adjustment screw through the nut and hole and tightening the adjustment screw against the inner telescoping leg portion.

19. The adjustable dish holder for pets according to claim 18, wherein the adjustment screw is hidden from view.
